(19) United States
(12) Patent Application Publication
(10) Pub. No.: US 2002/0099686 A1
(43) Pub. Date: Jul. 25, 2002

(54) Method and apparatus for analyzing a patient medical information database to identify patients likely to experience a problematic disease transition

(76) Inventors: Eric L. Schwartz, San Francisco, CA (US); Daniel M. Schwartz, San Francisco, CA (US); Christopher M. Quale, Richmond, CA (US)

Correspondence Address: COOLEY GODWARD, LLP, 3000 EL CAMINO REAL, 5 PALO ALTO SQUARE, PALO ALTO, CA, 94306, US

(21) Appl. No.: 09/917,228

(22) Filed: Jul. 29, 2001

Related U.S. Application Data
(60) Provisional application No. 60/221,094, filed on Jul. 27, 2000.

(51) Int. Cl. G06F 7/00

(52) U.S. Cl. 707/1

(57) ABSTRACT

A method and apparatus for modeling disease transitions in individuals includes the steps of identifying a population of individuals and defining a disease transition they could undergo. One or more variables are defined that represent medical information collected from these individuals. These variables are considered candidate variables that operate to predict the disease transition to varying degrees of accuracy. A logistic regression technique, along with information stored in an electronic database, are used to determine the degree of accuracy to which each candidate variable predicts the disease transition for the population of individuals. Certain candidate variables are then chosen according to how accurately they predict the disease transition. This set of chosen variables is then used to form a mathematical model, which in turn is used to predict this disease transition for that population of individuals.

### BRIEF DESCRIPTION OF THE INVENTION

This invention relates generally to the processing of medical data. More specifically, this invention relates to the analysis of patient medical information to identify patients likely to experience a problematic disease transition.

### BACKGROUND OF THE INVENTION

Modem medicine has established guidelines for the management of many chronic diseases. When properly followed, these guidelines often provide an effective way to manage these diseases and/or reduce the likelihood of secondary complications. Despite widespread acceptance of chronic disease care guidelines by health care providers, noncompliance with chronic disease care guidelines is common, both on the part of providers and patients. As an example, estimates of noncompliance rates for diabetes care range from fifty to ninety percent, depending on the patient population studied. As a result of not adhering to preventive care guidelines, many patients unnecessarily succumb to disabling and costly complications.

It is easy to see why noncompliance with chronic disease care guidelines is so widespread. The chronic nature of these diseases creates an ongoing burden for the patient, who must deal with a seemingly endless stream of provider appointments, laboratory tests at regular intervals, and the like. Given the magnitude of this responsibility, omissions by patients or even healthcare workers are certainly foreseeable.

Regardless of its cause, noncompliance with even routine aspects of chronic disease care guidelines can lead to devastating physical consequences for the patient. For example, it is well known that noncompliance with routine diabetes care frequently leads to complications as severe as blindness, kidney failure, amputation, and heart attack.

Compounding this problem is the ever-apparent shortage of funding and other resources available to the healthcare system. Simply put, the number of noncompliant patients who end up becoming ill places a strain on the system by requiring expensive hospitalization for complications that could have been avoided with proper adherence to care guidelines. One way around this problem is to target those patients at high risk for requiring hospitalization in the near future due to their recent noncompliance or due to some other factor. Health care resources can then be directed at those patients so as to prevent them from requiring hospitalization, or other expensive medical care, in the first place.

In light of the above, it would be desirable to be able to use already-gathered medical information to predict those patients who do not yet require expensive hospitalization but who are at risk of hospitalization in the near future. Instead of simply being distributed across the entire population, scant health care resources can thus be targeted to these at-risk patients, where they will go the farthest toward preventing needless future expenses. It would also be desirable to base these predictions on data stored in an electronic database, so that any predictive model could have ready access to information. In addition, such a model could use that access to evaluate the predictive accuracy of itself based on data that are subject to change, and could be updated relatively quickly to adapt to those changes. Finally, it would also be desirable to be able to readily access this database information so as to verify the accuracy of any data used.

### SUMMARY OF THE INVENTION

A method and apparatus for modeling disease transitions in individuals includes the steps of identifying a population of individuals and defining a disease transition they could undergo. One or more variables are defined that represent medical information collected from these individuals. These variables are considered candidate variables that operate to predict the disease transition to varying degrees of accuracy. A logistic regression technique, along with information stored in an electronic database, are used to determine the degree of accuracy to which each candidate variable predicts the disease transition for the population of individuals in previous time periods. Certain candidate variables are then chosen according to how accurately they predict the disease transition. This set of chosen variables is then used to form a mathematical model, which in turn is used to predict this disease transition for that population of individuals in a future time period.

In addition, a method and apparatus for verifying the processed electronic data of individual patients includes the step of writing patient data to an electronic file for reading by a browser program. Data location information is also written to the same electronic file. This data location information is capable of specifying the location of the patient data within an electronic database, but it is written into comment fields that do not operate to instruct the browser program to display the data location information to the user.

A further method and apparatus for verifying this data includes the step of receiving the aforementioned electronic file, and reading its patient data and associated data location information. The patient data is then written to an electronic verification database in a manner determined by the data location information. A patient medical information database, at least a portion of which has the same structure as the electronic verification database, is then queried. This query seeks to compare the contents of a particular location within the electronic verification database to the contents of the same location within that portion of the patient medical information database that has the same structure.

The method and apparatus of the invention allow for the construction and verification of a mathematical model that can use existing medical information to predict patients who do not yet require hospitalization but who are at risk of hospitalization in the near future. Hospitalizations tend to be expensive. The invention thus has the advantage of conserving scant health care resources by targeting those patients most likely to require hospitalization soon, so that a hospital stay can be prevented before it occurs.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer network constructed in accordance with an embodiment of the invention.

FIG. 2 illustrates processing operations that can yield a predictive model for use in accordance with an embodiment of the invention.

FIG. 3 is an example of a number of candidate variables that may be used in forming a predictive model utilized in accordance with an embodiment of the invention.

FIG. 4 is an example of patient data that may be processed in accordance with an embodiment of the invention.

FIG. 5 illustrates processing operations to verify patient data in accordance with an embodiment of the invention.

FIG. 6A is an example of Hyper Text Markup Language code that can be used to verify patient data in accordance with an embodiment of the invention.

FIG. 6B illustrates a sample browser screen displaying verification information in accordance with an embodiment of the invention.

FIG. 7 illustrates a sample browser screen displaying patient population selection information in accordance with an embodiment of the invention.

FIG. 8A illustrates a sample browser screen displaying a patient population in alphabetical order in accordance with an embodiment of the invention.

FIG. 8B illustrates a sample browser screen further displaying a patient population on the basis of risk score in accordance with an embodiment of the invention.

FIG. 9 illustrates a sample browser screen displaying patient information in accordance with an embodiment of the invention.

FIG. 10 illustrates a sample browser screen to record patient outreach activity in accordance with an embodiment of the invention.

Like reference numerals refer to corresponding parts throughout the several views of the drawings.

### DETAILED DESCRIPTION OF THE INVENTION

While it is rather easy to identify patients who are ill and consuming the lion's share of health care resources, it is difficult to select “healthy” patients who currently utilize few health care resources and are at near term risk of becoming ill. Many of the patients who are on the verge of hospitalization for chronic disease complications are non-compliant; however, they are a small subset of the entire non-compliant population. For example, while an estimated ninety percent of the patients in San Antonio, Tex.' military population are non-compliant with diabetes disease management protocols, only 5-10% will require hospitalization in the next year. If there were a way to predict who among the non-compliant patients were going to be hospitalized for complications, health care resources could be intensively targeted toward this high risk subset of the non-compliant population to reduce the number of hospitalizations across the population.

Non-compliance has become an issue because compliant patients are interacting appropriately with the health care system; if they become ill it is typically due to something besides lack of medical care. On the other hand, non-compliant patients are not exposed to the potential benefits of medical monitoring and treatment. In the absence of appropriate medical care, many non-compliant patients needlessly become ill and require expensive treatment for disease related complications.

The invention is directed toward identifying non-compliant patients that are at the highest risk of experiencing a problematic disease transition in the near future. Advantageously, the technique of the invention refines its predictive schema as medical information for the target population changes. This allows the invention to consistently identify the most at risk patients based upon the latest relevant information.

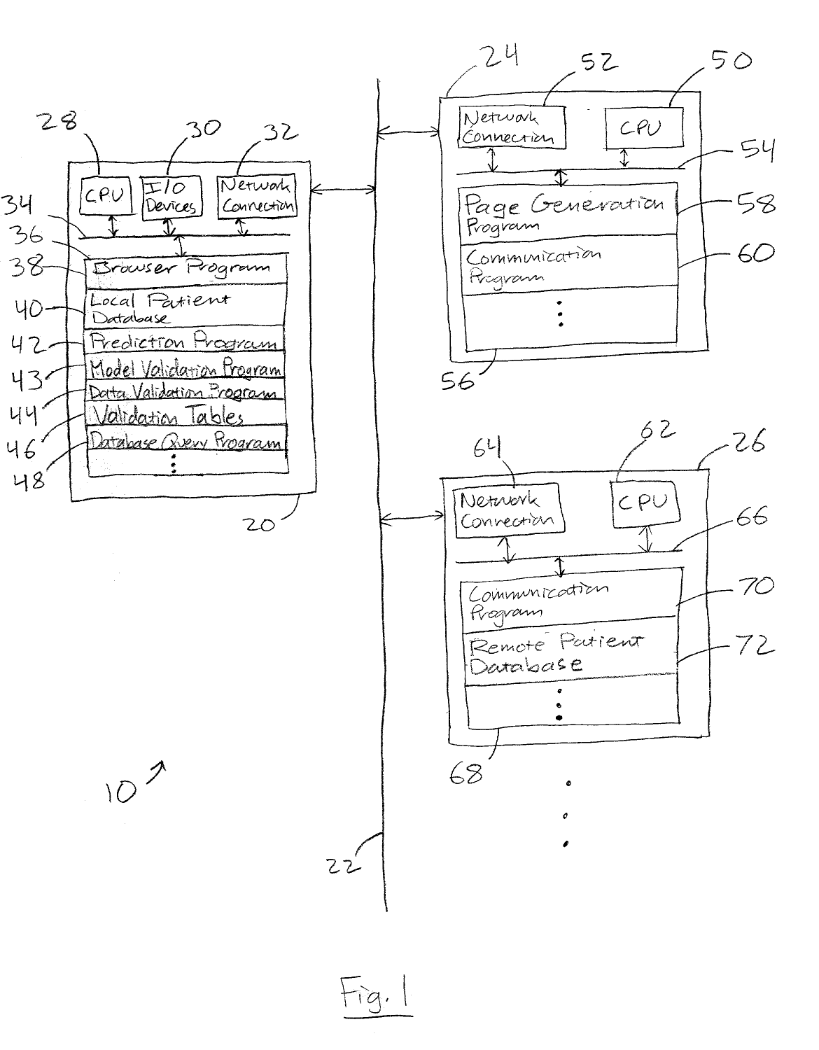

FIG. 1 illustrates a computer network 10 that may be operated in accordance with the present invention. The network 10 includes a computer 20 that may be a client computer. Computer 20 is connected by a transmission channel 22 to other computers 24 and 26 that may be server computers. Transmission channel 22 may be any wire or wireless transmission channel.

The computer 20 is a standard computer that includes a Central Processing Unit (CPU) 28, Input/Output (I/O) devices 30, and a network connection 32, all of which are connected by a bus 34 to a memory module 36. The I/O devices 30 allow the computer 20 to exchange information with a user, while the network connection 32 allows the computer 20 to communicate with other computers 24 or 26 over the transmission channel 22. The memory module 36 stores a number of databases, tables, and computer programs, including a browser program 38. The browser program 38 is a standard Internet browser configured to read conventional script files written in Hyper Text Markup Language (HTML), eXtensible Markup Language (XML), or other such computer programming languages, and to visually present the information received. As currently used, script files can contain instructions written in languages such as HTML or XML, as well as comment fields that assist programmers but do not instruct browsers to display information to a user. The browser program 38 can read script from files on the same computer 20, or on other computers 24 or 26, by communicating with them through the transmission channel 22. The memory module 36 also includes a local patient database 40 that stores medical information on patients for use by a prediction program 42. This prediction program 42 acts to generate a mathematical model for the prediction of problematic disease transitions. The model validation program 43 seeks to validate these predictions by comparing model predictions to existing data. The data validation program 44 acts to verify the accuracy of data by extracting information stored in browser pages, writing patient data to validation tables 46, and querying databases using database query program 48 to verify the data. The data validation program 44 extracts this information, which consists of textual information, by using a standard program for recognizing strings of text.

The computer 24 is a standard computer that includes a CPU 50 and network connection 52 for communication with other computers 20 and 26. The CPU 50 and network connection 52 are connected by a bus 54, which allows them to communicate with a memory module 56. This memory module 56 contains a page generation program 58 for generating script files to be read by programs such as a browser program 38. It also contains a communication program 60 that allows the computer 24 to communicate through its network connection 52 to other computers on its transmission channel 22.

The computer 26 is a standard computer that includes a CPU 62 and network connection 64 for communication with other computers 20 and 26. The CPU 62 and network connection 64 are connected by a bus 66, which allows them to communicate with a memory module 68. This memory module 68 contains a communication program 70 for allowing communications through network connection 64 to other computers on the transmission channel 22. It also contains a remote patient database 72, which is a standard electronic database configured to hold patient medical information for use with the invention.

The presence of two computers 24 and 26 in FIG. 1 reflects the typical case in which the remote patient database 72 and page generation program 58 reside on different servers. However, the invention also covers the situation in which both the remote patient database 72 and page generation program 58 reside on the same server.

In typical use in accordance with the invention, medical information on a patient population is entered into the local patient database 40 and is periodically uploaded to the remote patient database 72, which operates as a master database. A user may enter this information via an I/O device 30, or it may be transmitted from a remote database such as the remote patient database 72 of a remote computer 26. The prediction program 42 then accesses this medical information and uses it to construct a mathematical model operative to predict which patients from this population, if any, are likely to undergo a problematic disease transition.

The data validation program 44 can then act to verify the accuracy of the data used. In a typical client-server environment, this data validation program 44 instructs the page generation program 58 to create browser-readable script files containing patient information used by the prediction program 42. The generation program 58 is instructed to generate these script files in a certain format. Namely, patient information is written for possible display by a browser 38 when that browser 38 reads the script file.

Embedded in the comment fields of the script file, however, is data location information that indicates where, within a database, that patient information belongs. The data validation program 44 parses the comment fields of the script file to read this information, which is then used to copy patient information into validation tables 46 in an order specified by the data location information. The data location information typically mirrors the structure of the remote patient database 72. Patient information is therefore copied into tables 46 in the same order as the patient information in the remote patient database 72. Data from specific locations in the validation tables 46 can thus be directly compared with data from corresponding locations in the remote patient database 72. If the data from corresponding locations match, then it can be concluded that the data displayed on the screen are the same as the data in the remote patient database 72. If discrepancies between the two datasets arise, the method serves to indicate when the mathematical model in the program needs to be corrected.

Advantages are gained from the fact that the predictive model is generated with information from a specific patient population. Because the model is specific to a certain population, it is capable of identifying disease-causing factors that may not appear in larger studies. For instance, a predictive model generated using the population of a given town may identify local factors specific to that town, such as local factories, whose effects would not appear in a nationwide study. Also, the electronic nature of information used means the model can be easily updated to reflect changes in patient populations. For instance, as people move in and out of a city, it is easy to simply capture all database information on people with the same city name in the address field, and build a revised model accordingly.

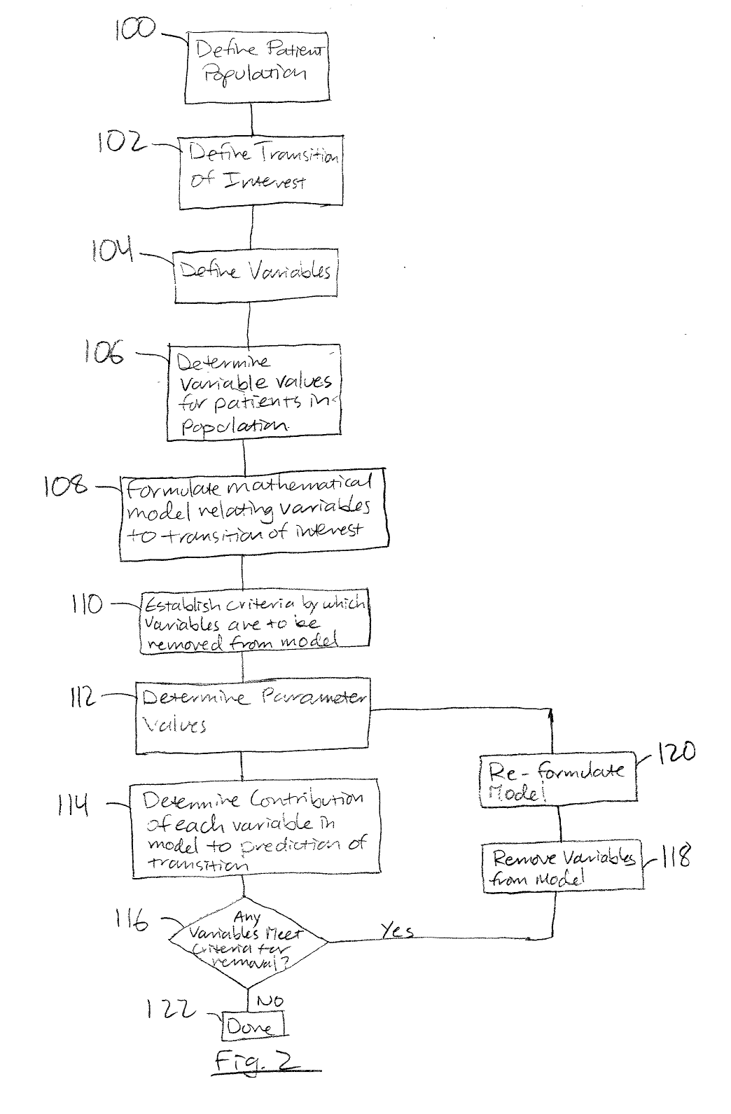

FIG. 2 illustrates processing steps of a method for generating a predictive model in accordance with the invention. A patient population is first defined by any appropriate criteria (step 100). Medical information on the individuals in this population, however it is defined, typically is contained in a remote patient database 72. A problematic disease transition is then defined (step 102). Typically, this transition is one in which a patient with a chronic disease shifts from a physical condition not requiring hospitalization to a physical condition requiring hospitalization. The invention need not be so limited, however, and in fact should be construed to cover any disease transition where a patient traverses from one definable state to another.

Once the patient population and disease transition are identified, certain variables are defined (step 104). These variables can include any variable capable of indicating a patient's physical condition including without limitation such variables as age, race, gender, blood pressure, creatinine levels, number of heart attacks experienced, and the like. These candidate variables each serve as predictors of the already-defined disease transition to various degrees; some are good predictors and some are not. Often, it is not yet known which are good and which are not. For example, if the disease transition is specified as the contracting of adult-onset diabetes, candidate variables that may serve as predictors could be blood sugar level, blood pressure, amount of exercise per week, age, and race. Some, such as blood sugar level, are known to be good predictors of diabetes. Others, such as age and race, may be less effective; empirical data are needed to help craft a mathematical model to determine whether they are good predictors or not. Until such a model is crafted though, it is unknown whether these variables should be part of a good predictive model or not.

Once these candidate variables are defined, values for each can be determined (step 106). Typically, values are found for each variable and for each individual in the patient population. These values can be found, for instance, by reading them from a database such as database 40 or database 72. At this point, the requisite information has been accumulated and a mathematical model relating these variables to the disease transition can now be formulated (step 108).

It is worth noting here that the process is only half-complete. The model contains a number of important variables, such as blood sugar level, that serve as good predictors of a transition to diabetes. However, it also contains other variables such as age, race, and gender which may not act as good predictors and which would thus be useless as predictors. Their presence in the model would serve only to waste computational resources. These types of variables should be removed from the model. The next processing step is thus to establish criteria by which variables with marginal predictive values, should they exist, are to be removed from the model (step 110).

Typical mathematical models involve the use of a number of variables as well as a number of associated parameters that, in one sense, help determine the relative contribution of each variable to the model as a whole. To determine which variables to remove, therefore, each parameter must also be determined (step 112). Once this occurs, the relative contribution of each variable to the overall model can be determined (step 114). If any variables meet the established criteria for removal (step 116), they are removed from the model (step 118). A new model is reformulated using the remaining variables (step 120) and the process is repeated from step 112 until no variables meet the criteria for removal, at which point the process terminates (step 122).

The method outlined in FIG. 2 is more easily understood with reference to a specific example. In accordance with step 100, assume a patient population consisting of ten patients is defined, and the necessary medical information is available for all ten of them. In accordance with step 102, the disease transition is defined to occur when a patient transitions from requiring little medical care expenses to requiring high medical care expenses due to diabetic complications in a particular index year. In practice, expense is often used as a proxy for less-quantifiable terms such as “health” or “severity of diabetes.”

It is worth mentioning that, while the example is specific to diabetes and its complications, the invention should not be construed as limited in this manner. Rather, the invention should be construed as simply including a means of predicting any disease transition capable of being modeled mathematically.

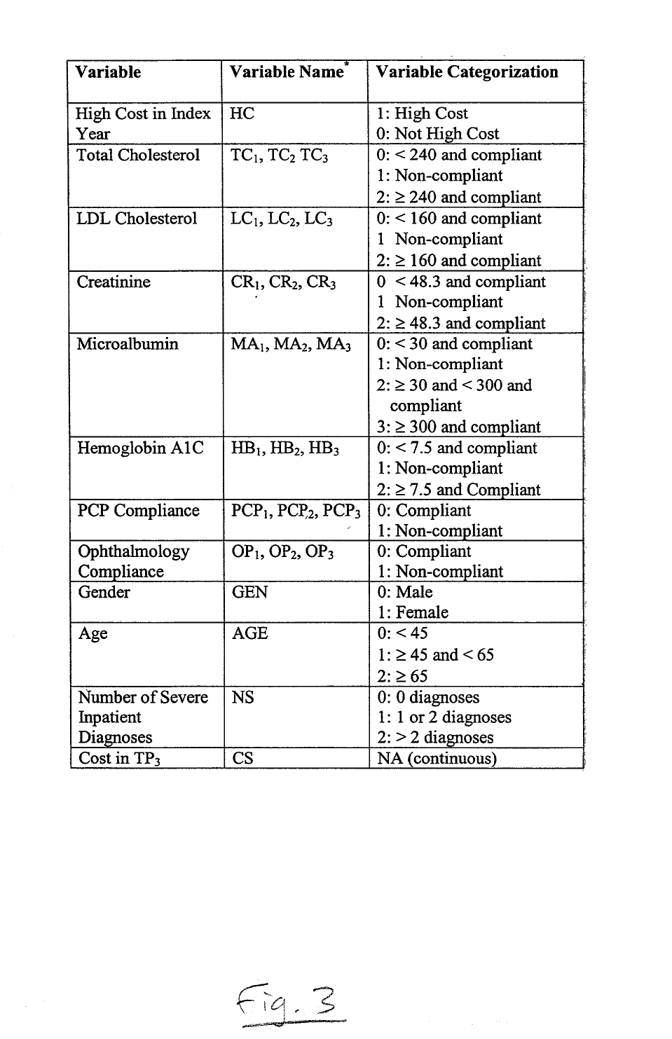

FIG. 3 illustrates step 104, in which the variables are defined for use in the model. Here, the variables are listed in the left column of FIG. 3, with corresponding labels in the middle column. Note that some variables use subscripts to indicate measurements of the same quantity during different time periods. For example, a patient's Low-Density Lipoprotein (LDL) cholesterol level is given by the variable “LDL Cholesterol” for three different time periods, represented by LC₁, LC₂, and LC₃. Each is treated as a separate variable in the mathematical, or predictive, model. In this example, the three different time periods can be the past three years, so if the model seeks to predict cost in year 4, the three time periods would cover years 1, 2, and 3. Note further that many of the variables are not continuous; they have only a finite number of discrete states. For example, the gender variable “GEN” can take on only two states, 0 (male) and 1 (female). The specific categorizations of each variable are given in the rightmost column of FIG. 3. In this example, the only continuous variable is the projected cost in time period 3, TP₃.

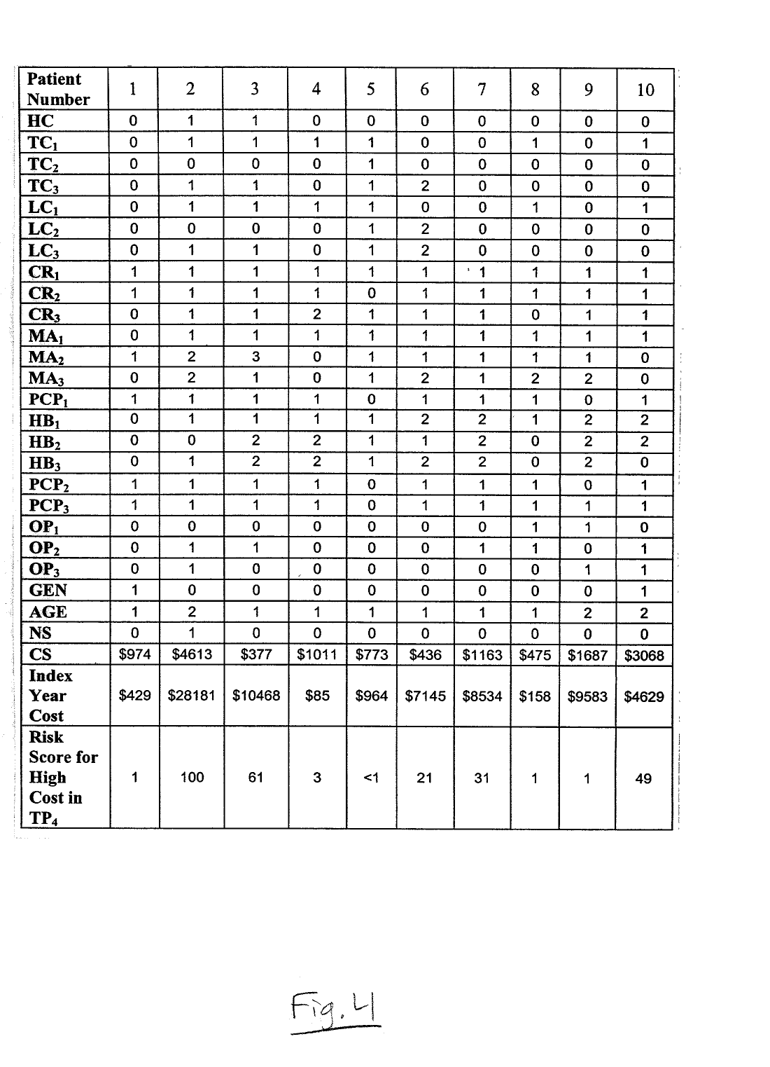

FIG. 4 illustrates step 106, in which sample data are given for each variable and for all ten patients. As above, in some embodiments the prediction program 42 can read this sample data from the local patient database 40, while in others it can read the data from the remote patient database 72.

According to step 108, a mathematical model is now formulated which relates the candidate variables listed in FIG. 3 to the desired result: patient cost in the index year. The model is typically built and verified using existing patient data. For instance, if data are collected for years 1, 2, 3, and 4, the index year may be year 5. The model would then be built using data from years 1 through 4, and predictions would be made for, say, year 4. The model validation program 43 can then check these predictions against existing patient cost information for year 4 by any known means, such as tracking the absolute value of discrepancies between predicted and actual costs. Excessive discrepancies would indicate inaccuracies in the model, in which case the model could be reformulated to improve its accuracy. However, accurate “predictions” of year 4 cost mean the model can be considered sufficiently reliable to make predictions of year 5, for which data do not yet exist.

In this example, a standard Generalized Linear Model (GLM) can be used (See, e.g., McCullagh and Nelder, GENERALIZED LINEAR MODELS, Chapman and Hall, 1989). A solution is determined using a standard logistic regression technique known in the art and explained in the equations below.

In this model a representation of the solution, or linear predictor, is assumed equal to a linear combination of n candidate variables, or:

$$η = {\sum }_{j = 0}^{n - 1} {x}_{j} {β}_{j} \qquad ( 1 )$$

where η represents the linear predictor, each xⱼ is a candidate variable, and each βⱼ is an as-yet undetermined coefficient. The linear predictor is assumed equal to a logit function of the solution, probability of high patient cost in the index year, or P_{HC}:

$$η = ln ( \frac{{P}_{HC}}{1 - {P}_{HC}} ) \qquad ( 2 )$$

In this GLM method, it is known that equation (1) will remain valid if each discrete variable is represented functionally, and each continuous variable is assumed to take on a polynomial form. Thus, equation (1) becomes, for this example:

$$ln ( \frac{{P}_{HC}}{1 - {P}_{HC}} ) = {β}_{0} + {f}_{TC} ( {β}_{1} , {β}_{2} , {TC}_{1} ) + {f}_{TC} ( {β}_{3} , {β}_{4} , {TC}_{2} ) + {f}_{TC} ( {β}_{5} , {β}_{6} , {TC}_{3} ) + {f}_{AGE} ( {β}_{7} , {β}_{8} , AGE ) + … + {β}_{19} CS + {β}_{20} {CS}^{2} + {β}_{21} {CS}^{3} \qquad ( 3 )$$

where

ƒ_{TC}(β₁, β₂, TC₁)=0 if TC₁ is equal to 0 (Total Cholesterol <240 and compliant)

ƒ_{TC}(β₁, β₂, TC₁)=β₁ if TC₁ is equal to 1 (non-compliant with respect to TC)

ƒ_{TC}(β₁, β₂, TC₁)=β₂ if TC₁ is equal to 2 (Total Cholesterol 240 and compliant)

and

ƒ_{TC}(β₁, β₂, TC₂)=0 if TC₂ is equal to 0 (Total Cholesterol <240 and compliant)

ƒ_{TC}(β₃, β₄, TC₂)=β₃ if TC₂ is equal to 1 (non-compliant with respect to TC)

ƒ_{TC}(β₃, β₄, TC₂)=β₄ if TC₂ is equal to 2 (Total Cholesterol 240 and compliant)

and so on. The ellipses indicate the remainder of discrete variables listed in FIG. 3, which are represented in the same functional form as TC₁ and TC₂, but would be too cumbersome (and probably confusing) to list in their entirety. The continuous variable CS is represented as a third order polynomial but could be represented as a polynomial of any order without violating equation (1) or the scope of the invention.

Once equation (3) is formulated, step 108 is complete. According to step 110, criteria are now established by which variables are to be removed from equation (3). The metric used for deleting particular variables is the standard P-value test described below, with the P-value taken as less than 0.15. Note that a particular discrete candidate variable has a number of degrees of freedom M equal to the number of possible values it can take on. For example, TC₁ has three degrees of freedom as it can take on values of 0, 1, or 2. Assume an equation with the same form as equation (3) that contains all candidate variables, and call this equation M1. In order to determine whether TC₁ should be deleted or not, a model M2 is fitted, which is the same as M1 except all terms containing TC₁ are omitted (i.e., the ƒ_{TC}(β₁, β₂, TC₁) term is not in the model). Now define a test statistic TS, where: TS=−2[ln(L2)−ln(L1)] (4)

and ln( . . . ) refers to the natural logarithm function. Also, ln(L2) and ln(L1) are the “maximized log likelihoods” of models M2 and M1, respectively. This quantity is defined later in equation (9). It is known that TS approximately follows a standard Chi-square distribution with M−1=m degrees of freedom. For TC₁ then, the appropriate Chi-square distribution would have 3−1=2 degrees of freedom. The P-value for TC₁ is then the probability that a Chi-square random variable with m degrees of freedom is greater than TS:

$$P ( {χ}_{m}^{2} > TS ) = 1 - {\int }_{0}^{TS} \frac{1}{{2}^{m / 2} Γ ( m / 2 )} {v}^{( m / 2 ) - 1} {ⅇ}^{- v / 2} ⅆ v \qquad ( 5 )$$

where Γ is the standard Gamma function, known to have the form:

$$Γ ( x ) = {\int }_{0}^{∞} {u}^{x - 1} {ⅇ}^{- u} ⅆ u \qquad ( 6 )$$

As discussed above, the metric by which candidate variables are to be removed is set at a P-value less than or equal to 0.15. This serves as an indicator of whether a particular variable makes enough of a contribution over a random variable to be considered as making a contribution to the model. There is no steadfast rule as to why 0.15 is chosen; the value is somewhat of a rule of thumb but is nevertheless effective in this embodiment.

Once step 110 is completed by, in this case, establishing a P-value removal criterion, the individual parameters βⱼ are determined in step 112. The parameters are determined by using the maximum likelihood method, for which no closed form solution exists. Rather, an iterative algorithm must be employed. This is a standard technique that first requires an initial guess for each βⱼ, where typically an initial value of 0.0 for each βⱼ is sufficient.

The following will explain how to get the estimate of β in the k+1^{st} iteration (βₖ₊₁) from the estimates obtained from the k^{th} iteration (βₖ). The different components of the iterative technique are the vectors Y, Z, P_{HC}, and and the matrices and X and W. If i denotes the number of patients in the analysis, then the vector Y is an i×1 vector of the responses, namely the element yₘ of Y is 1 if patient m was high cost in the index year and 0 otherwise. Z is an i×1 vector (sometimes referred to as the “working response vector”) derived from the estimates β^{k}. Specifically, elements zₘ of the vector Z are defined as follows:

$${z}_{m} = {η}_{m} + ( {y}_{m} - {P}_{HC , m} ) \frac{ⅆ {η}_{m}}{ⅆ {P}_{HC , m}} \qquad ( 7 )$$

where the value ₘ is calculated by plugging in the values of βₖ and the candidate variable values for patient m into equation (1). P_{HC,m} can be calculated by solving equation (2) for P_{HC,m} (specifically, P_{HC}=1+e⁻).

The matrix X (sometimes referred to as the “design matrix”) is an i×n matrix where the xₘⱼ^{th} element is the j^{th} candidate variable value for the m^{th} subject (note that the first element of each row is 1, corresponding to β₀ in (3)). The W (or “weight”) matrix is a diagonal i×i matrix whose m^{th} diagonal elements wₘ=P_{HC,m}(1−P_{HC,m}).

In order to get βₖ₊₁, the following equation is used:

βₖ₊₁=(X^{T}X)⁻¹X^{T}WZ (8)

The iterations continue until the natural logarithm of the “likelihood” function has been maximized. The natural logarithm of the likelihood function is defined by:

$$l ( {P}_{HC} ; Y ) = {\sum }_{m = 1}^{i} {y}_{m} ln ( \frac{{P}_{HC , m}}{1 - {P}_{HC , m}} ) + ln ( 1 - {P}_{HC , m} ) \qquad ( 9 )$$

This maximization occurs when the absolute difference between the log likelihood functions calculated based on estimates βₖ and the βₖ₊₁ (for some value k) falls below a threshold known as the convergence criterion. This convergence criterion can be arbitrarily established, but a commonly used one that terminates this iterative process is 0.00001. The end result of step 112 is a convergent set of n coefficients βⱼ, each of which is based on the entire set of patient information.

Once β is converged upon (thus establishing parameter values), step 114 commences. The contribution of each variable is determined by calculating equation (5) for each variable listed in FIG. 3. If a variable's P-value falls below 0.15 it is removed from equation (3). If not, it is kept. Equation (3) is then re-formulated without these removed variables, and the process repeats until no further variables are removed. All that remains are variables that meaningfully contribute to the prediction of patient cost in the index year.

The details of subsequent iterations are omitted, as they are simply mechanical repetitions of the process as it is already explained. However, completion of the process reveals that, for this example, the remaining meaningful variables are AGE, GEN, NS, CS (when modeled as a third degree polynomial), TC₁, CR₂, CR₃, HB₂, HB₃, and MA₂. All other candidate variables were removed according to the P-value removal criterion. The completed predictive model thus has only these variables and their corresponding coefficients β.

The bottom row of FIG. 4 summarizes the results of the above process. For each patient, the above process is executed to produce a predicted likelihood of high costs in the index year, P_{HC}. In the interest of producing more easily understood results, each predicted likelihood P_{HC} (which, recall, is a percentage value) is divided by the largest value among the ten results, multiplied by 100, and rounded to the nearest whole number. This scales all results so that the patient with the greatest predicted likelihood of high cost in the index year is assigned a “risk score” of 100; all other patients are assigned lower risk scores. The model validation program 43 can compare these risk scores against actual patient costs in the index year to determine how well the model performs. Here, for example, the model has relatively accurately predicted low costs for patients 1, 4, and 8. It has also relatively accurately predicted high costs for patients 2, 3, and 10.

The above steps can be repeated in order to verify the predictive accuracy of the model once it is in use. Should there be a change in the patient population (for example new therapies or a shift in the demographic makeup of the population), the processing steps of FIG. 2 can be repeated, and a new predictive model built, to reflect these changes. This can allow the predictive model to be transparently updated so as to reflect the most current data.

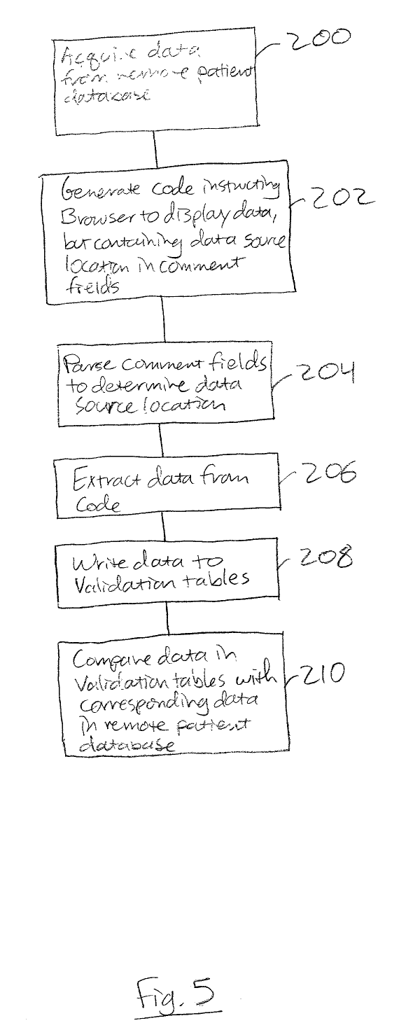

FIG. 5 illustrates data validation processing steps in accordance with the invention. Typically, it is convenient for patient data to be viewed on a computer screen. However, the mere act of arranging this data in a user-viewable format may create errors if performed improperly. The invention includes, therefore, a method of comparing the data viewed on-screen to the data as it existed before arranging into user-viewable format.

Other reasons exist in support of this aspect of the invention. It is often convenient for patient data to be downloaded only periodically from a remote patient database 72, for instance when users are allowed only limited access, or unlimited access is expensive. In these cases, data downloaded to a local patient database 40 can be outdated. The validation, or verification, process provides a way to determine whether this information is up to date. In addition, the verification process will point out any inaccuracies in data transfer from the remote patient database 72 to the local patient database 40. These can occur, for instance, when data transfer is performed manually, or when the data are subject to intervening calculations while enroute from the remote patient database 72 to the local patient database 40.

The first step in accordance with the invention is to acquire data from a remote database such as the remote patient database 72 (step 200). The second step is to generate code instructing a browser program 38 to display this acquired data. This code also contains data source location information in the applicable comment fields (step 202). This location information indicates where, within the structure of remote patient database 72, each piece of patient information belongs. This allows the data validation program 44 to write patient data to the validation tables 46 in the same structure as this data appears in the remote patient database 72. Corresponding locations within the two structures should thus contain identical data; if not, then the act of arranging data for screen presentation may have introduced errors.

The next processing step is therefore to parse the code's comment fields to determine this location information (step 204). Corresponding patient data are also extracted (step 206), and data are written to the validation tables 46 in a structure determined by the location information (step 208). These validation tables 46 are standard database files generated by any normal means. While FIG. 1 shows these tables 46 resident on a particular computer 20, they can be generated and/or resident on any computer in the network 10, so long as the data validation program 44 can access them. The information at each specified location within this structure can then be compared to the information at a corresponding location in the remote patient database 72 (step 210).

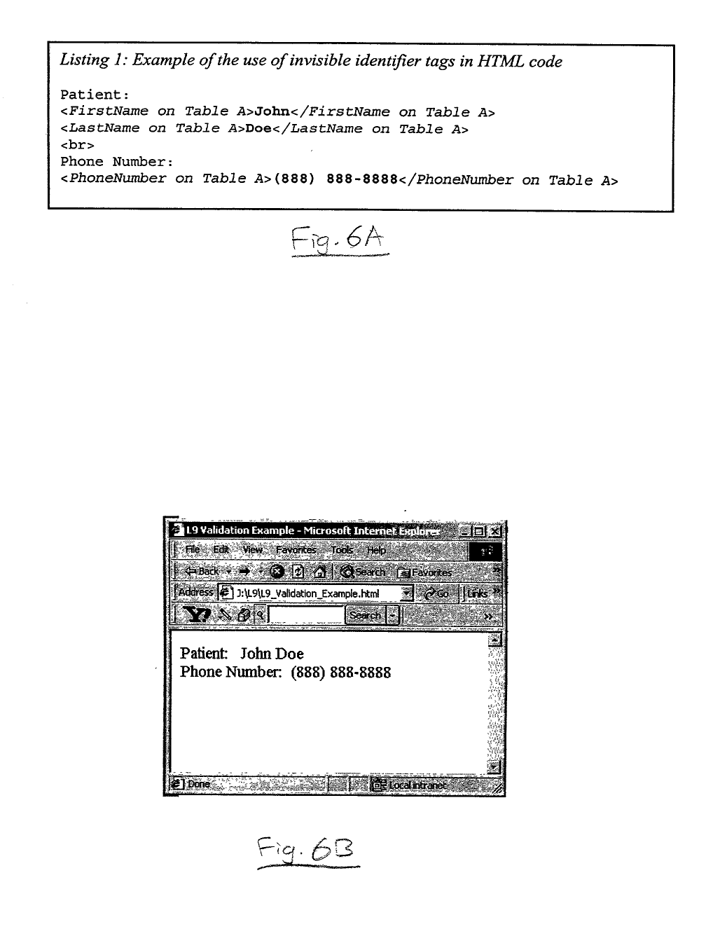

The method outlined in FIG. 5 is more easily understood with reference to a specific example. In accordance with step 200, assume that patient data have been acquired from a remote database 72. In accordance with step 202, script must now be generated that contains this patient data. It must also contain location data within its comment fields. FIG. 6A illustrates a sample HTML script file written in accordance with this step. Patient data (in this case, name and phone number) are shown in bold, where their existence outside of the bracketed comment fields indicates that a browser program 38 will display them visually. The brackets designate the beginning and end of comment fields; everything in-between goes undisplayed by the browser 38.

Note that patient data are left outside brackets for display simply as a matter of convenience: often it helps the user to see the data. Whether the data get visually displayed, however, has no bearing on the invention, which simply discloses a method of storing data location information in an undisplayed manner. Those of skill in the art will recognize that the invention can be extended to include writing patient data to comment fields, where they can be parsed and extracted in the same manner as any corresponding location information.

Within the brackets is data source location information indicating that the name “John Doe” should be placed as the first and last names on Table A. Also within brackets is information indicating that “(888) 888-8888” should be placed as the phone number on Table A. At step 204, the data validation program 44 parses the standard character strings in the comment fields according to well known methods for recognizing text strings. It therefore recognizes the “<” and “>” symbols as indicating the beginning and end of comment fields. Similarly, it recognizes the “on” as indicating a break between table information and information indicating location within that table. In that way, it recognizes that “John” is to be placed at location “FirstName” on “Table A” of validation table 46. According to step 206, the patient data, recognized by the data validation program 44 as text strings outside any comment field or within its own comment field, is extracted and displayed if necessary.

The validation program, according to step 208, then writes this data to the validation tables 46 using the location information it has parsed. By step 210, this data can then be compared to corresponding data in a remote patient database 72 using a standard database query program 48, which queries the remote patient database 72 for the appropriate data and compares it to the contents of the validation tables 46.

FIG. 6B illustrates a sample browser screen generated by a browser program 38 after reading a script file written in accordance with the invention. The screen display is generated in accordance to the commands given in FIG. 6A. Note that the patient data are displayed visually, whereas the corresponding data location information is not.

Another way of viewing the invention is in connection with the following 4-step methodology. The first step of the methodology is to determine the patient identification scheme and relevant time period for the gathering of data. For example, the patient identification scheme may be to choose those patients in a given database who presently meet one or more clinical criteria for diabetes, or who have been prescribed diabetic drugs in the past. The relevant time period may be chosen as including medical data for the past three years. The second step of the methodology is to gather and organize data. Patient data may be taken from the local patient database 40, from the remote patient database 72, or from another source.

The third step of the methodology is to build and validate the predictive model using patient data gathered in the second step of the methodology. For example, the model can be built using data from a randomly selected 75% of those patients found using the patient identification scheme. The model can then be checked by applying the model to the remaining 25% of these patients. Actual costs in the index year can be compared to the estimated probability of high cost in the index year. The model can be deemed reliable if a sufficient number of patients predicted as likely high cost patients actually turn out to be, and if a sufficient number of patients predicted as not high cost actually turn out to be. The fourth step of the methodology is to implement the model by applying it to those patients who were found using the patient identification scheme and who are currently low cost patients. The goal in this fourth step is, of course, to determine which of these low cost patients are likely to become high cost patients during an upcoming time index.

The remaining figures exemplify practical results of an embodiment of the invention. These figures illustrate how the prediction program 42 and the data validation program 44 interact to create an environment where at-risk patients can be predicted and their information accurately displayed for possible contact by a healthcare worker. Once patient information is updated, the prediction program 42 can be executed to revise that patient's risk score. The data validation program 44 can then be executed to display and verify any relevant information to assist in contacting that patient if necessary. In this manner, patients with high risk scores can be contacted, and health care resources thus directed toward them, before hospitalization or another disease transition occurs.

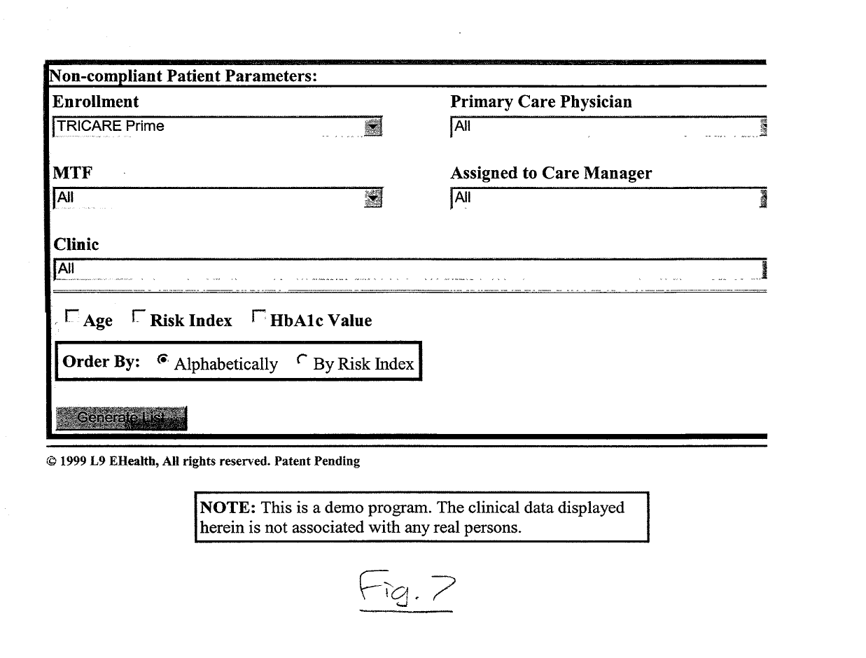

FIG. 7 illustrates a sample browser screen displaying patient population selection information. Users can choose a patient population according to criteria listed in each pull-down menu. For example, patients can be selected by their enrollment in a particular insurance plan, by their primary care physician, or by the care manager to whom they are assigned. In this manner, step 100 of FIG. 2 can be carried out and the process of building a predictive model begun.

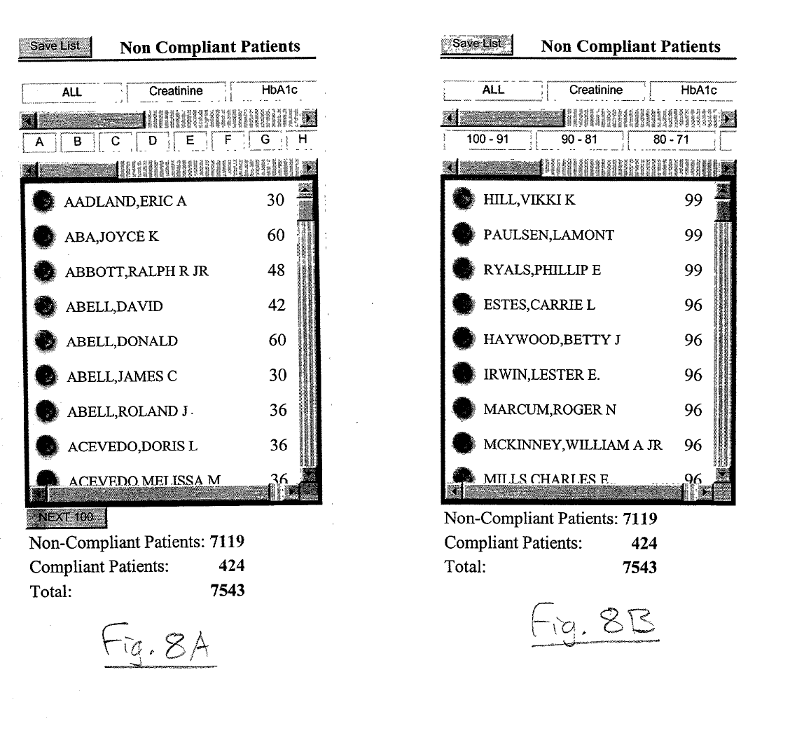

Once a predictive model has been built and patients have been assigned risk scores, the list of patients and their associated risk scores can be displayed. FIG. 8A illustrates a sample browser screen displaying results according to an embodiment of the invention. Here, a patient population was selected and assigned risk scores according to the processing steps of FIG. 2. The patient population, along with corresponding results, has then been displayed in alphabetical order. Note the risk scores, which are values between 1 and 100, displayed for each patient. FIG. 8B illustrates a sample browser screen displaying a patient population arranged in descending order of risk score. This arrangement makes it easier for users to identify patients with the highest predicted risks of undergoing a disease transition. Observe that the information in FIGS. 8A and 8B includes the total number of non-compliant patients. If any data change, the processing steps of FIG. 2 can be repeated to update risk scores accordingly. In this manner, patient risk scores can dynamically reflect changes in the patient population, and urge allocation of health care resources accordingly.

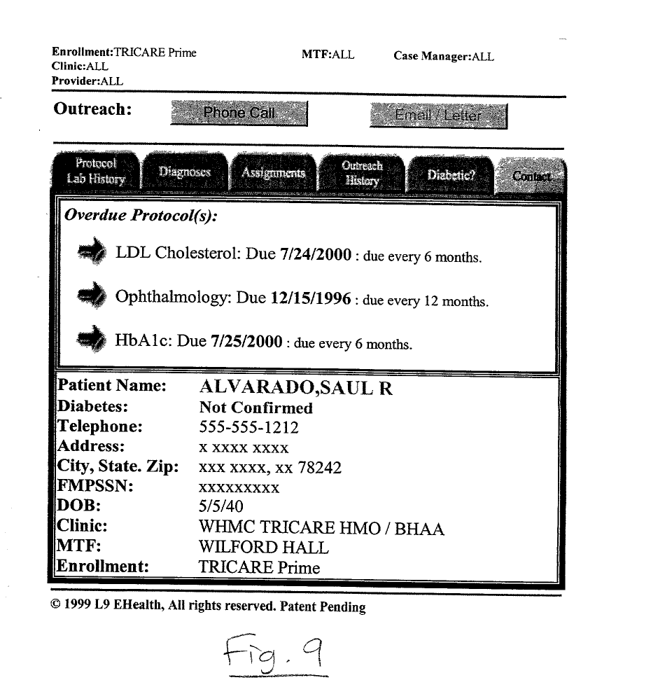

Once patients with high risk scores have been identified, the processing steps of FIG. 5 can be used to confirm their information and display data required to contact them. FIG. 9 illustrates a sample browser screen displaying information on a hypothetical patient who has been identified due to his risk score. According to the above processing steps, a page generation program 58 has created a script file containing information on this patient. The data validation program 44 can read the corresponding data and their locations, and check their accuracy against a remote patient database 72. The browser screen then displays information read from the script file. In this manner, information is displayed to allow health care resources to be directed toward this patient.

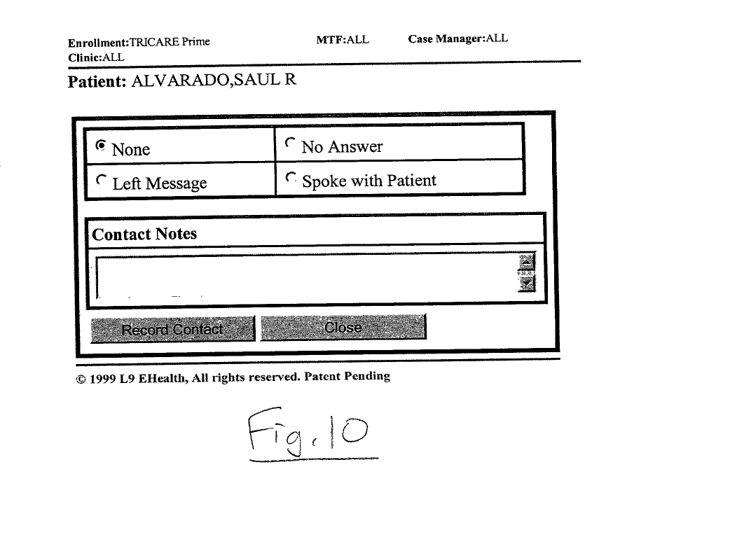

FIG. 10 illustrates a sample browser screen to record efforts to contact a patient and encourage him or her to seek medical treatment. Once an attempt is made at patient contact, information regarding this attempt can be entered and saved for future use. For example, a note that the patient no longer resides at that address can be recorded, so that a new address can be obtained and entered into the remote patient database 72.

FIGS. 7-10 demonstrate the practical impact of the present invention. A health care worker can instantaneously generate a list of patients that are at risk of suffering a problematic disease transition. Observe that the predictive model is created from, and applied to, the most recent medical data. Therefore, the list of high-risk individuals can change on a daily basis, or even faster. Thus, for example, the hypothetical individuals listed in FIG. 8B may change at any time. Observe in FIG. 9 that the health care worker is provided with comprehensive medical information on a patient when the patient is selected from the non-compliant patient lists of FIGS. 8A or 8B. This type of comprehensive real-time predictive information provides health care workers with an important tool to reduce health care costs.

Tracking a chronic disease population and assigning risk for a particular outcome is a dynamic process, occurring in an ongoing manner as population data change. For example, patients move, appointments are kept or missed, new drugs are started, laboratory tests reveal new problems, diagnoses emerge or resolve, etc. The methods of the invention can thus, for instance, be implemented to continuously extract patient data from the database 72 to perform the following functions: 1) identification of patients with a specified condition, 2) tracking the identified patients for compliance with disease management protocols, and 3) predicting who among the non-compliant patients is at highest risk for specified outcomes. As new data emerge for a population, these functions can also be performed in automated fashion. This allows users to manage the population using the most current information and the most population-specific predictive model available. All of these functions can be seamlessly integrated and presented to the user.

Another useful feature of the invention is the capacity to continuously search for patients at risk for specific conditions. For instance, patients over the age of 45 who are obese and non-Caucasian are at higher risk for undiagnosed diabetes. The invention can be implemented to periodically mine the most current data on the remote patient database 72 to generate lists of patients requiring, for example, screening, fasting, and/or blood sugar examination for undiagnosed diabetes. Similar screening protocols can be used to generate lists and automatically contact patients at risk for other diseases such as cancer, heart disease, infectious diseases, etc. Naturally, certain combinations of predictors for undiagnosed conditions will prevail among one population, say in San Antonio, while other predictors will be superior in other demographically distinct regions of the country. As patients are screened and determined to have or not have a particular undiagnosed condition, predictive models in specific regions can be automatically refined to improve predictability as described above for patients with known disease states.

The foregoing description contains examples in which aspects of the invention are carried out in the context of diabetes. Within this context, the various aspects of the invention are more easily carried out when use is made of certain databases. More specifically, the invention is suited for use with the Integrated Clinical Database (ICDB) currently deployed in Region VI of the United States military. The ICDB is a relational database containing years of medical data on military personnel (both active and retired) and their dependents. Included in the ICDB are such data as International Classification of Diseases, revision 9 (ICD9) codes, prescriptions given and filled, lab tests and results, cost, and demographic information. The data contained in the ICDB are of particular use in building a predictive model that seeks to estimate the probability of future disease transitions for these military personnel. As mentioned above however, the invention should not be construed as limited to predicting only those disease transitions associated with diabetes. Instead, the invention should be construed as including any disease transition capable of prediction.

The foregoing description, for purposes of explanation, used specific nomenclature to provide a thorough understanding of the invention. However, it will be apparent to one skilled in the art that the specific details are not required in order to practice the invention. In other instances, well-known programs and network elements are shown in cursory form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Obviously, many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method of identifying individuals susceptible to incurring a disease transition, said method including:
(A) identifying a population of individuals;
(B) defining a disease transition;
(C) defining one or more variables representing medical information collected from said population of individuals, wherein each of said one or more variables is a candidate variable operating to predict said disease transition to various degrees of accuracy;
(D) selectively choosing variables from said candidate variables so as to form a set of chosen variables, wherein said choosing includes using a logistic regression technique, and wherein said choosing further includes using information stored in an electronic database to determine the degree of accuracy to which each said candidate variable acts to predict said disease transition for said population of individuals; and
(E) using said set of chosen variables in a mathematical model to predict said disease transition for said population of individuals.

2. The method of claim 1 wherein (A), (B), (C), (D), and (E) are repeated in order from time to time in response to changes in the information stored in said electronic database.

3. The method of claim 1 wherein said disease transition is defined, for an individual, as converting from a state in which said individual does not require hospitalization for a symptom of a disease, to a state in which said individual requires hospitalization for a symptom of a disease.

4. The method of claim 1 wherein said disease transition is further defined, for an individual, as converting from a state in which said individual does not require hospitalization for a symptom of diabetes, to a state in which said individual requires hospitalization for a symptom of diabetes.

5. A method of identifying individuals susceptible to incurring a disease transition, said method including:
(A) identifying a population of individuals;
(B) defining a disease transition;
(C) defining one or more variables representing medical information collected from said population of individuals, wherein each of said one or more variables is a candidate variable operating to predict said disease transition to various degrees of accuracy;
(D) creating a mathematical model wherein said model contains one or more variables from said set of candidate variables, and wherein said model is capable of determining a likelihood that individuals from said population of individuals will undergo said disease transition; and
(E) refining said model by performing a logistic regression technique using information stored in an electronic database, so as to render said model operative to predict said disease transition for said population of individuals.

6. The method of claim 5 wherein (A), (B), (C), (D), and (E) are repeated in order from time to time in response to changes in the information stored in said electronic database.

7. The method of claim 5 wherein said disease transition is defined, for an individual, as converting from a state in which said individual does not require hospitalization for a symptom of a disease, to a state in which said individual requires hospitalization for a symptom of a disease.

8. The method of claim 5 wherein said disease transition is defined, for an individual, as converting from a state in which said individual does not require hospitalization for a symptom of diabetes, to a state in which said individual requires hospitalization for a symptom of diabetes.

9. A method of identifying individuals susceptible to incurring a disease transition, said method including:
(A) identifying a population of individuals;
(B) defining a disease transition;
(C) defining one or more variables representing medical information collected from said population of individuals, wherein each of said one or more variables is a candidate variable operative to predict said disease transition to various degrees of accuracy;
(D) querying an electronic database to determine a numerical value for each variable in said set of candidate variables, and for each individual in said population of individuals;
(E) establishing one or more criteria for said candidate variables, wherein said criteria are mathematically related to a metric that can be calculated for a candidate variable, and that reflects the contribution of a candidate variable to the prediction of said transition;
(F) formulating a mathematical model relating said candidate variables to said disease transition;
(G) using said numerical values in said mathematical model to determine said metric for each candidate variable of said model;
(H) removing candidate variables from said model based on said one or more criteria;
(I) repeating (F), (G), and (H) in order until no variables are removed from said set of candidate variables; and
(J) using said mathematical model to identify said disease transition for said population of individuals.

10. The method of claim 9 wherein (A), (B), (C), (D), (E), (F), (G), (H), (I), and (I) are repeated in order from time to time in response to changes in the information stored in said electronic database.

11. The method of claim 9 wherein said disease transition is defined, for an individual, as converting from a state in which said individual does not require hospitalization for a symptom of a disease, to a state in which said individual requires hospitalization for a symptom of a disease.

12. The method of claim 9 wherein said disease transition is defined, for an individual, as converting from a state in which said individual does not require hospitalization for a symptom of diabetes, to a state in which said individual requires hospitalization for a symptom of diabetes.

13. A method of verifying data used to identify individuals susceptible to incurring a disease transition, said method including:
writing patient data to an electronic file for reading by a browser program; and
writing data location information to comment fields in said electronic file, wherein said data location information is capable of specifying the location of said patient data within an electronic database, and wherein said comment fields do not operate to instruct said browser program to display said data location information.

14. The method of claim 13 wherein said patient data and said data location information are written to said electronic file in Hyper Text Markup Language.

15. A method of verifying data used to identify individuals susceptible to incurring a disease transition, said method including:
receiving an electronic file containing patient data for reading by a browser program, and further containing data location information within comment fields, wherein said data location information is capable of specifying the location of said patient data within an electronic database, and wherein said comment fields do not operate to instruct said browser program to display said data location information;
reading said data location information from said comment fields, and said patient data from said electronic file;
writing said patient data to an electronic verification database in a manner determined by said data location information; and
querying a patient medical information database, at least a portion of which having the same structure as said electronic verification database, so as to compare the contents of a particular location within said electronic verification database to the contents of the same location within said same structure of said patient medical information database.

16. The method of claim 15 wherein said patient data and said data location information are written to said electronic file in Hyper Text Markup Language.

17. A computer-readable memory that can be used to direct a computer to function in a specified manner, comprising:
(A) an electronic database configured to store electronic information;
(B) instructions to identify a population of individuals;
(C) instructions to define a disease transition;
(D) instructions to define one or more variables representing medical information collected from said population of individuals, wherein each of said one or more variables is a candidate variable operating to predict said disease transition to various degrees of accuracy;
(E) instructions to selectively choose variables from said candidate variables so as to form a set of chosen variables, wherein said instructions to selectively choose include instructions to use a logistic regression technique, and wherein said instructions to selectively choose further include instructions to use information stored in said electronic database to determine the degree of accuracy to which each said candidate variable acts to predict said disease transition for said population of individuals; and
(F) instructions to use said set of chosen variables in a mathematical model to predict said disease transition for said population of individuals.

18. The computer-readable memory of claim 17 wherein said disease transition is defined, for an individual, as converting from a state in which said individual does not require hospitalization for a symptom of a disease, to a state in which said individual requires hospitalization for a symptom of a disease.

19. The computer-readable memory of claim 17 wherein said disease transition is defined, for an individual, as converting from a state in which said individual does not require hospitalization for a symptom of diabetes, to a state in which said individual requires hospitalization for a symptom of diabetes.

20. A computer-readable memory that can be used to direct a computer to function in a specified manner, comprising:
(A) an electronic database configured to store electronic information;
(B) instructions to identify a population of individuals;
(C) instructions to define a disease transition;
(D) instructions to define one or more variables representing medical information collected from said population of individuals, wherein each of said one or more variables is a candidate variable operating to predict said disease transition to various degrees of accuracy;
(E) instructions to create a mathematical model wherein said model contains one or more variables from said set of candidate variables, and wherein said model is capable of determining a likelihood that individuals from said population of individuals will undergo said disease transition; and
(F) instructions to refine said model by performing a logistic regression technique using information stored in said electronic database, so as to render said model operative to predict said disease transition for said population of individuals.

21. The computer-readable memory of claim 20 wherein said disease transition is defined, for an individual, as converting from a state in which said individual does not require hospitalization for a symptom of a disease, to a state in which said individual requires hospitalization for a symptom of a disease.

22. The computer-readable memory of claim 20 wherein said disease transition is defined, for an individual, as converting from a state in which said individual does not require hospitalization for a symptom of diabetes, to a state in which said individual requires hospitalization for a symptom of diabetes.

23. A computer-readable memory that can be used to direct a computer to function in a specified manner, comprising:
(A) an electronic database configured to store electronic information;
(B) instructions to identify a population of individuals;
(C) instructions to define a disease transition;
(D) instructions to define one or more variables representing medical information collected from said population of individuals, wherein each of said one or more variables is a candidate variable operative to predict said disease transition to various degrees of accuracy;
(E) instructions to query said electronic database to determine a numerical value for each variable in said set of candidate variables, and for each individual in said population of individuals;
(F) instructions to establish one or more criteria for said candidate variables, wherein said criteria are mathematically related to a metric that can be calculated for a candidate variable, and that reflects the contribution of a candidate variable to the prediction of said transition;
(G) instructions to formulate a mathematical model relating said candidate variables to said disease transition;
(H) instructions to use said numerical values in said mathematical model to determine said metric for each candidate variable of said model;
(I) instructions to remove candidate variables from said model based on said one or more criteria;
(J) instructions to execute (G), (H), and (I) repeatedly in order until no variables are removed from said set of candidate variables; and
(K) instructions to use said mathematical model to identify said disease transition for said population of individuals.

24. The computer-readable memory of claim 23 wherein said disease transition is defined, for an individual, as converting from a state in which said individual does not require hospitalization for a symptom of a disease, to a state in which said individual requires hospitalization for a symptom of a disease.

25. The computer-readable memory of claim 23 wherein said disease transition is defined, for an individual, as converting from a state in which said individual does not require hospitalization for a symptom of diabetes, to a state in which said individual requires hospitalization for a symptom of diabetes.

26. A computer-readable memory that can be used to direct a computer to function in a specified manner, comprising:
instructions to write patient data to an electronic file for reading by a browser program; and
instructions to write data location information to comment fields in said electronic file, wherein said data location information is capable of specifying the location of said patient data within an electronic database, and wherein said comment fields do not operate to instruct said browser program to display said data location information.

27. The computer-readable memory of claim 26 wherein said patient data and said data location information are written to said electronic file in Hyper Text Markup Language.

28. A computer-readable memory that can be used to direct a computer to function in a specified manner, comprising:
instructions to receive an electronic file containing patient data for reading by a browser program, and further containing data location information within comment fields, wherein said data location information is capable of specifying the location of said patient data within an electronic database, and wherein said comment fields do not operate to instruct said browser program to display said data location information;
instructions to read said data location information from said comment fields, and said patient data from said electronic file;
instructions to write said patient data to an electronic verification database in a manner determined by said data location information; and
instructions to query a patient medical information database, at least a portion of which having the same structure as said electronic verification database, so as to compare the contents of a particular location within said electronic verification database to the contents of the same location within said same structure of said patient medical information database.

29. The computer-readable memory of claim 28 wherein said patient data and said data location information are written to said electronic file in Hyper Text Markup Language.
